(19) United States
(12) Patent Application Publication
(10) Pub. No.: US 2025/0054744 A1
(43) Pub. Date: Feb. 13, 2025

(54) METHOD AND APPARATUS FOR MASS SPECTROMETRY

(71) Applicant: OHIO STATE INNOVATION FOUNDATION, Columbus, OH (US)

(72) Inventors: Abraham BADU-TAWIAH, Columbus, OH (US); Dmytro KULYK, Columbus, OH (US)

(21) Appl. No.: 18/924,341

(22) Filed: Oct. 23, 2024

Related U.S. Application Data
(62) Division of application No. 17/607,521, filed on Oct. 29, 2021.
(60) Provisional application No. 62/840,100, filed on Apr. 29, 2019.

(51) Int. Cl. H01J 49/16; H01J 49/00

(52) U.S. Cl. CPC H01J 49/167; H01J 49/0031; H01J 49/168

(57) ABSTRACT

Disclosed herein are methods and systems for ionizing organic compounds by exposing head space vapors to corona discharge. The methods and systems are suitable for high throughput screening of samples, including biofluids. The methods and systems are suitable for rapid evaluation of chemical reactions, permitting discovery of novel organic reaction pathways.

### CROSS-REFERENCE TO RELATED APPLICATION

This application claims the benefit of U.S. Provisional Application 62/840,100, filed on Apr. 29, 2019, the contents of which are hereby incorporated in its entirety.

### STATEMENT OF GOVERNMENT SUPPORT

This invention was made with government support under CHE-1801971, awarded by the National Science Foundation; and DE-SC0016044, awarded by the Department of Energy. The government has certain rights in this invention.

### FIELD OF THE INVENTION

The invention is directed to methods of ionizing and analyzing organic compounds, as well as systems and devices for doing the same.

### BACKGROUND

The advent of ambient mass spectrometry (MS) enabled rapid analysis of complex mixtures without pre-treatment. This capability was made possible through various desorption processes that selectively transfer the analyte of interest (not the whole multiphase sample) to the mass spectrometer. This feature of ambient ionization is attractive because experiments are performed outside of the vacuum environment of the mass spectrometer, which allow direct access to sample during analysis. Aside from quantitation and high throughput requirements, another important merit in the biomedical field is the analysis of microsamples (<50 μL) with minimal dilution.

Many studies have investigated various aspects of the nESI setup, including (i) the mode by which the analyte solution is electrically charged (i.e., contact versus non-contact), (ii) the source/nature of the electrical energy (e.g., piezoelectric discharge, triboelectric nano-generator, pulsed DC/AC voltage and square-wave potential), (iii) flow-rate manipulation to control ion suppression and sample consumption (e.g., via the use of smaller tip on-demand pulsed charges), (iv) reduction of electrical current (via the use of high input ohmic resistance) to avoid destructive corona discharge phenomenon when electrospraying under high voltage conditions and (v) the use of other operational tricks like step voltage and polarity reverse applications. None of these methods are completely adequate, especially for simultaneous generation of different ion types.

There remains a need for an integrated, robust, and versatile nESI system that can quantitatively and rapidly ionize polar and non-polar organic compounds, and large bio-molecules in various matrices.

### SUMMARY

Disclosed herein are methods of detecting and analyzing samples using corona discharge to ionize headspace vapors or electrostatically attracted particles. Analytes can be detected at extremely low concentrations. Also disclosed herein are apparatus

The details of one or more embodiments are set forth in the descriptions below. Other features, objects, and advantages will be apparent from the description and from the claims.

### BRIEF DESCRIPTION OF THE FIGURES

FIG. 1: Ionization chamber with separate ESI and corona electrode.

FIG. 2: Ionization chamber with integrated ESI and corona electrode.

FIG. 3: Types of analyzes that can be ionized with the disclosed systems and methods.

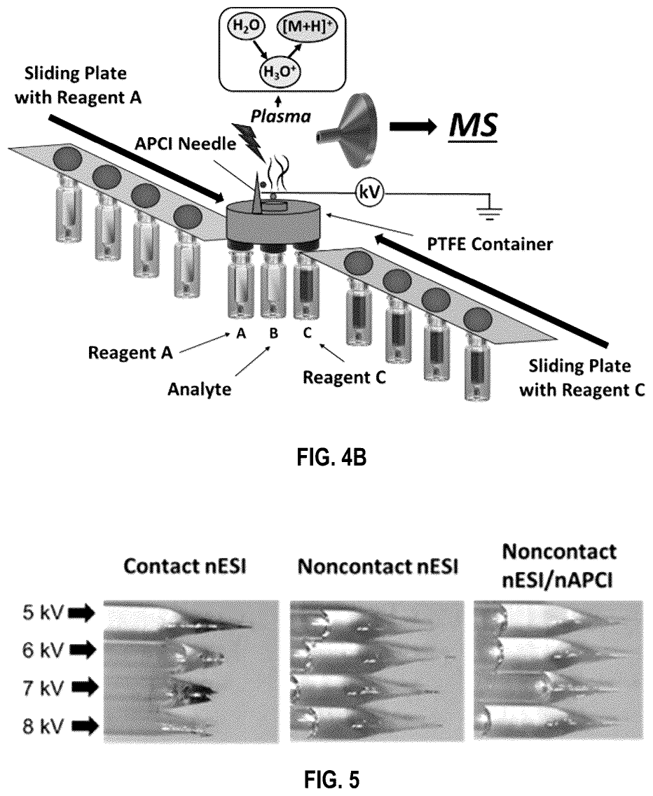

FIG. 4A: Ionization chamber with integrated ESI and corona electrode, reagent gas valve, and plurality of sample containers.

FIG. 4B: Schematic of contained-APCI MS screening platform. Containers (A, B, C) can be filled (<100 μL) with different reagent combinations (A, C) and analyte (B), and robotically or manually exposed to corona discharge (thunder icon) by sliding plates. Headspace vapor or electrostatically attracted particles of reagents react with each other in in the gas-phase upon plasma initiation through the application of high direct current (DC) voltage (4-6 kV) to the stainless-steel needle. Detection of reaction products is conducted by mass spectrometry in real-time.

FIG. 5: Photographs showing the effect of Joule heating on stability of emitter tip (filled with water) for contact nESI, noncontact nESI, and noncontact nESI/nAPCI sources.

FIG. 6: Photograph showing in-capillary liquid/liquid extraction of cocaine from whole human blood (5 μL) by ethyl acetate.

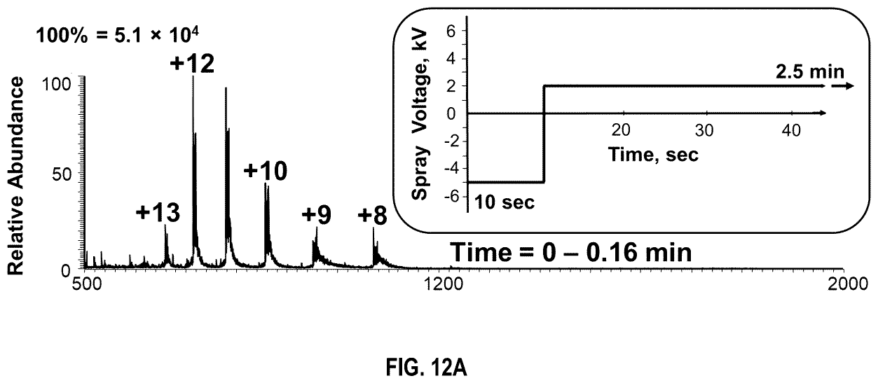

FIG. 7: Flowrate measurements for nESI MS and nESI/nAPCI MS. MeOH/H2O was sprayed at 1 kV and 200° C. for 30 min for each electrospray tip (3 tips were employed for each method). Solvent mass difference before and after spraying along with solvent density (0.9119 g/mL) were used to calculate flowrates. Measured flowrates were 61 nL/min and 47 nL/min for nESI and nESI/nAPCI respectively.

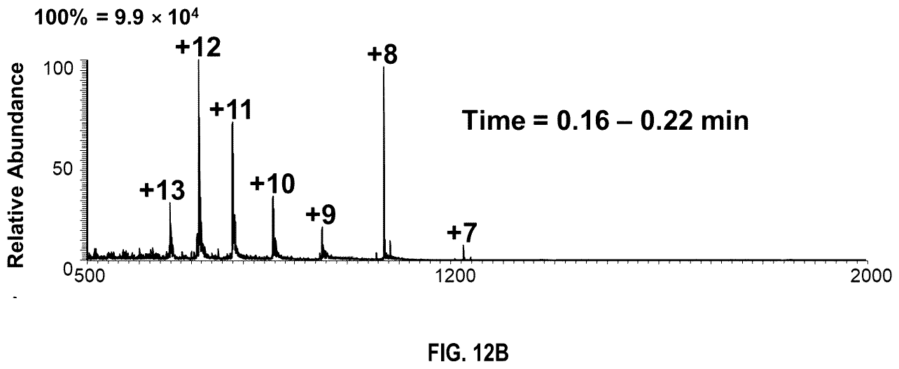

FIG. 8: Measurement of analyte-to-internal standard (A/IS) signal ratio when using 3 μL and 5 μL ethyl acetate solvent (containing 500 ppb of cocaine-D3) to extract 300 ppb of cocaine from human serum. A/IS recorded for using 3 μL ethyl acetate was 10 times higher for than when 5 μL because of concentration effects.

FIG. 9: Comparison of cocaine ionization efficiency in ethyl acetate versus ethyl acetate solvent that is saturated with 2% water. Cocaine concentration of both solvents was 100 ppb. Three samples were tested for each solution. FIGS. 10A-10B: (FIG. 10A) Optical image showing the size of nESI tips measured by microscope and (FIG. 10B) microscope stage micrometer calibration slide with 10 micron line resolution. The nESI tip size was determined to be approximately 5 μm.

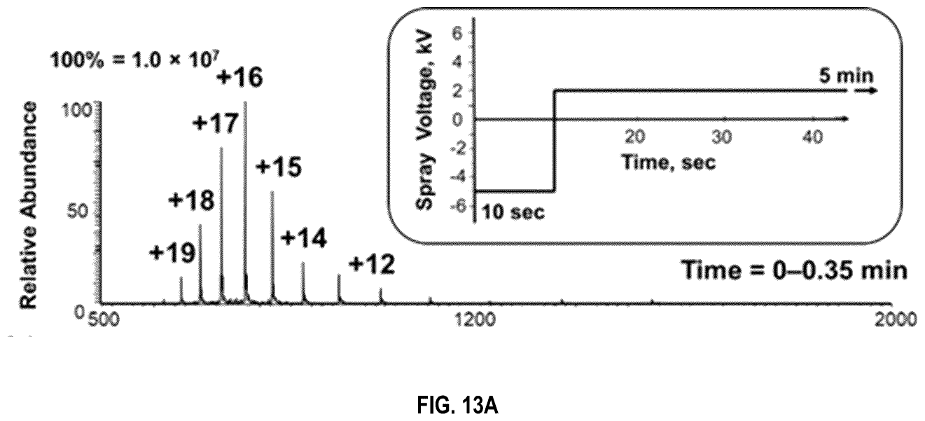

FIG. 11: MS/MS analysis of 300 ppb cocaine following seven cycles of in-capillary extractions from the same human serum sample (5 μL with spiked 500 ppb of cocaine-D3). Each extraction cycle was performed using a fresh ethyl acetate solvent (3 μL). For each extraction, new nESI tip was used to reanalyze serum that contained ethyl acetate leftover. Analyte to internal standard (A/IS) signal ratio was normalized to the A/IS of the 1^{st} extraction and was stable for 7 consequent extractions with variation within 98-100%.

FIGS. 12A-12C: Electrophoretic desalting of 45 uM ubiquitin in PBS (1X) solution by electrophoretic separation mode of noncontact nESI/nAPCI (step voltage: −5 kV to +2 kV, see the insert). Each spectrum show a different analysis time domain, from 0-0.16 min (FIG. 12A), to 0.16-0.22 min (FIG. 12B), to 0.22-2.5 min (FIG. 12C). Note: no acid was added to the solution.

FIGS. 13A-13C: Electrophoretic desalting of 45 uM of cytochrome c in PBS (1X) solution (137 mM NaCl, 2.7 mM KCl, 10 mM Na2HPO4 and 1.8 mM KH2PO4) in the presence of 0.1% of formic acid using the noncontact nESI-nAPCI setup, with a step voltage function start-ing with −5 kV for 10 s before switching to +2 kV for 5 extra minutes (see the insert in FIG. 13A) where mass spectra were recorded. FIGS. 13A-13C show selected mass spectra at different time domains, namely 0-0.35 min, 0.35-1.3 min and 1.3-5 min, respectively.

FIG. 14: Quantification of blood samples spiked with cocaine (50-1000 pg/mL) and 500 pg/mL cocaine-D3 as IS using nESI/nAPCI MS2 with MRM (transitions m/z 304→182 and m/z 307->185 for the analyte and IS, respectively). Insert shows MS2 of cocaine at 50 pg/mL level.

FIG. 15: (a) Total ion chromatogram, TIC, and 15b-f: extracted ion chromatograms (EIC) of high-throughput screening involving reaction of 2-butanone with (b) butylamine (product m/z 128), (c) phenylhydrazine (product m/z 163), (d) ethanolamine (product m/z 116), (e) pentylhydrazine (product m/z 157), and (f) aniline (product m/z 148). Reaction time was kept at 5 s per sample, followed by another 5 s wait time to limit carryover issues.

FIG. 16A-16C: Analysis of 200 μM equimolar mixture of 5-fluorouracil (1), caffeine (2), β-estradiol (3), cocaine (4), and vitamin D2 (5) in methanol by conventional nESI (FIG. 16A) and noncontact nESI/nAPCI (FIG. 16B) methods operated at 2 and 6 kV spray voltages, respectively. FIG. 16C=compound key.

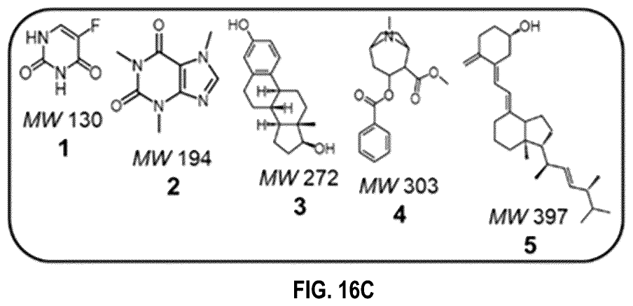

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes-from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Disclosed herein are methods for detecting organic compounds in an analyte composition. The composition can be placed in an enclosed chamber defining a headspace and an outlet, the outlet in fluid communication with the headspace. An ESI electrode, which is proximate to the composition, is supplied with a direct current voltage to generate charged droplets.

The electrodes used in the disclosed methods and systems can be formed from any suitably conductive metal, for instance silver, iron, platinum, iridium, ruthenium, or a combination thereof. The ESI electrode can be insulated by a suitable non-conductive material, e.g., glass, plastic, poly (tetrafluoroethylene), fiberglass, rubber, ceramic and the like. Glass, including borosilicates and quartz, is a particularly preferred insulator. The total thickness of the insulator can be from 0.05-1.0 mm, from 0.05-0.75 mm, from 0.05-0.5 mm, from 0.1-0.5 mm, from 0.1-0.4 mm, or from 0.2-0.5 mm. For embodiments in which the electrode is a wire, glass rods having inner diameters ranging from 0.2-2.0 mm, from 0.2-1.5 mm, from 0.5-1.5 mm, or from 1.0-1.5 mm can serve as the insulator.

In some embodiments the droplets pass through the outlet and are then exposed to a corona discharge, while in other embodiments the analyte composition is directly contacted with the corona discharge. The corona discharge can be produced by the same ESI electrode, or can be produced by a different, corona electrode. For embodiments in which the corona discharge is produced by the same ESI electrode, the ESI electrode is supplied with a voltage that is sufficient to also produce a corona discharge. For instance, the ESI electrode can be supplied with a voltage that is at least 3.0 kV, at least about 3.5 kV, at least about 4.0 kV, at least about 4.5 kV, at least about 5.0 kV, at least about 6.0 kV, at least about 7.0 kV, at least about 8.0 kV, at least about 9.0 kV, or at least about 10.0 kV. In some embodiments, the applied current can be from 3-15 kV, from 3-10 kV, from 4-15 kV, from 4-10 kV, from 5-10kV, from 4-8 kV, from 4-6 kV, or from 3-6 kV. When the ESI electrode is separate from the corona generating electrode, the applied voltage can be lower, for instance at least about 0.5kV, at least about 1.0 kV, at least about 1.5 kV, at least about 2.0 kV, at least about 2.5 kV, at least about 3.0 kV, at least about 3.5 kV, at least about 4.0 kV, at least about 4.5 kV, at least about 5.0 kV, at least about 6.0 kV, at least about 7.0 kV, at least about 8.0 kV, at least about 9.0 kV, or at least about 10.0 kV. In some embodiments, the applied current can be from 0.5-15kV, from 0.5-10 kV, from 2-15 kV, from 2-10 kV, from 2-5 kV, from 5-10 kV, from 3-8kV, or from 4-6 kV.

In some embodiments, the ESI electrode does not directly contact the analyte composition. For instance, the electrode can be spaced from the composition at a distance that is from about 0-10 cm, from about 0-8 cm, from about 0-6 cm, from about 0-4 cm, from about 0-2 cm, from about 0-1 cm, about 0 cm, from about 0.1-10 cm, from about 0.1-5 cm, from about 0.1-1.5 cm, or from about 0.5-1.5 cm. In other embodiments, the electrode does in fact directly contact the analyte composition. For small molecule organic compounds, it is preferred that the ESI electrode does not contact the analyte composition. For biopolymer organic compounds, it can be preferred that the ESI electrode does contact the analyte composition. Small molecules include non-polymeric compounds having a molecular weight less than or equal to about 1,500 Da. Biopolymers include peptides, proteins, nucleic acids, and polysaccharides, may be ionized by contacting the sample with the outer surface of the insulator.

In some instances, a solvent can be placed in the enclosed chamber between the analyte sample and the outlet. The analyte composition and/or charged droplets contact the solvent, thereby increasing the sensitivity of the analytical method. Preferred solvents include organic solvents, including polar aprotic solvents like ethyl acetate and acetone, or polar protic solvents like methanol and acetic acid. In some instances, the organic solvent can further include from 0.1-5% (v/v) water.

The ionized compounds are detectable and quantifiable, and so the outlet can be in fluid communication with an analyzer, for instance a mass spectrometer. The ionized compounds may be analyzed using an ion trap mass spectrometer, Orbitrap mass spectrometer, or triple quadrupole mass spectrometer. In some embodiments, the ionized compounds may be combined with a gas, for instance an inert carrier gas, prior to transfer to the ionizer. The ionized compounds may be combined with the gas either by ionizing the compounds in the presence of a gas, or by introducing a gas into a chamber containing the ionized compounds. In certain embodiments, the ionized compounds may be combined with a reagent, for instance, an acid, a base, an oxidant, a solvent, or a combination thereof. The ionized compounds can be combined with the aforementioned gases and reagents prior to exposure to the corona discharge.

The enclosed chamber can be made from a suitable non-conductive material, e.g., glass, plastic, poly (tetrafluoroethylene), fiberglass, rubber, ceramic and the like. Glass, including borosilicates and quartz, is a particularly preferred insulator. The ESI electrode can be disposed with the headspace region defined by the enclosed ionization chamber, or the electrode can be integrated with one or more walls of the ionization chamber. In such cases, the insulating material is also present in the walls of the chamber.

In some instances, a voltage sequence may be employed to ionize the organic compounds. For instance, a first voltage can be applied for a first period of time, followed by applying a second voltage for a second period of time, in which the first and second voltages differ either in magnitude or polarity. In some instances, the first and second voltages are of opposite polarity, i.e., first voltage is of negative polarity, and the second voltage is of positive polarity; or first voltage is of positive polarity, and the second voltage is of negative polarity.

The first period of time can be from 1-60 second, from 1-40 seconds, from 1-30seconds, from 1-20 seconds, from 5-30 seconds, from 5-20 seconds, or from 5-15 seconds. The second period of time can be at least 5 seconds, at least 30 seconds, at least 60 seconds, at least 90 seconds, at least 120 seconds, or at least 150 seconds.

A variety of different analyte compositions may be used in the disclosed methods and systems. For instance, biofluid such as urine, blood serum, plasma, saliva, sweat, tears, and combinations thereof may be analyzed for the presence of small molecules and/or biomarkers.

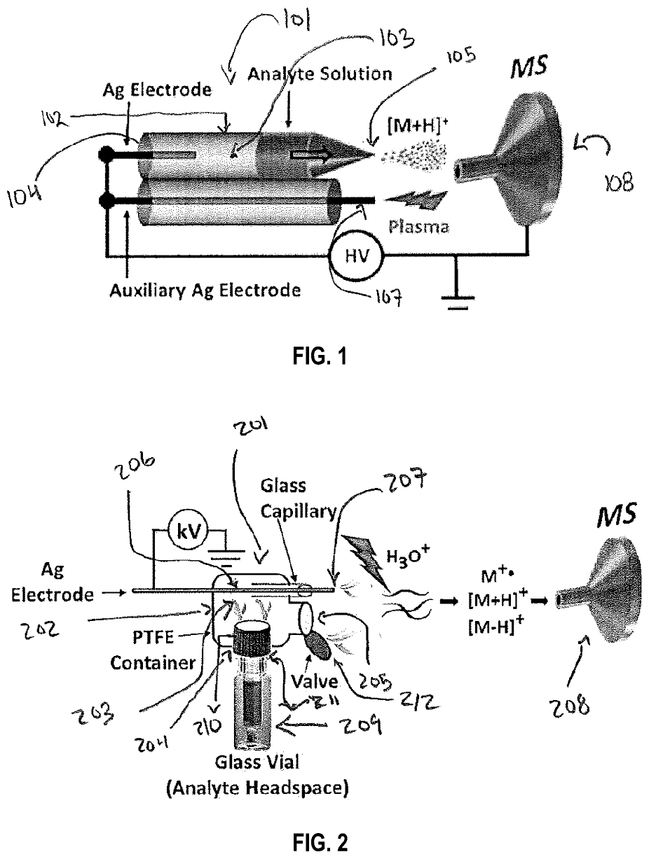

An exemplary system is depicted in FIG. 1. An ionization chamber (101) is provided that includes an enclosed vessel (102) defining a headspace (103), an inlet (104) and an outlet (105), the inlet and outlet each in fluid communication with the headspace, the inlet for receiving an analyte; an ESI electrode (106) in electrical communication with the headspace; a separate corona electrode (107) disposed outside the chamber and adjacent to the outlet; and the outlet is configured to permit fluid communication between the headspace and an analyzer (108).

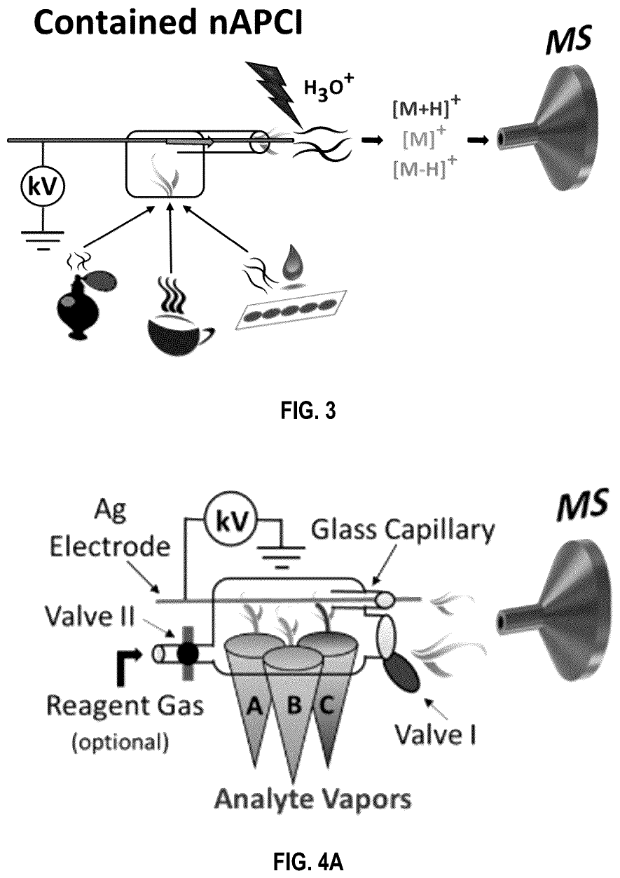

A second exemplary system is depicted in FIG. 2, wherein the ESI electrode and corona electrode are physically integrated. An ionization chamber (201) is provided that includes an enclosed vessel (202) defining a headspace (203), an inlet (204) and an outlet (205), the inlet and outlet cach in fluid communication with the headspace, the inlet for receiving an analyte; an ESI electrode portion (206) in electrical communication with the headspace; a corona electrode portion (207) that is electrically integrated with the ESI electrode, disposed outside the chamber and adjacent to the outlet; and the outlet is configured to permit fluid communication between the headspace and an analyzer (208). Outlet (205) includes a recloseable valve (212) thereby permitting fluid communication with the analyzer, and may be closed, thereby restricting the ionized compounds to the chamber.

In FIG. 2, the inlet is removably coupleable to an analyte container (209). The inlet can include a threaded surface (210) for coupling to a mating threaded surface (211) of an analyte container, a snap on attachment for coupling with a mating containing, or other coupleable combinations known to those of skill in the art.

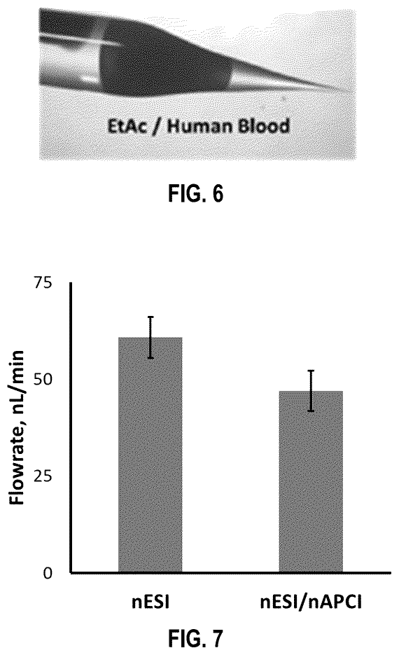

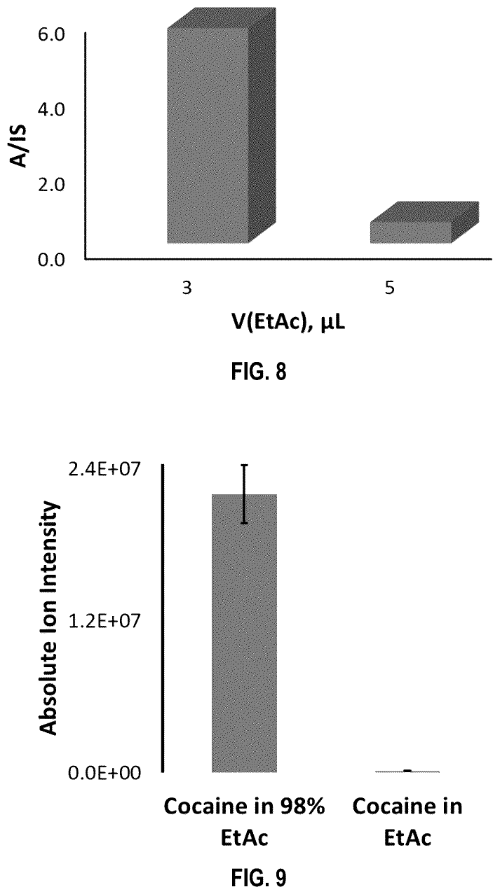

For some embodiments, such as shown in FIG. 4A, the enclosed vessel can include a plurality of inlets for attaching a plurality of analyte containers. The enclosed vessel can also include a gas valve, configured to permit fluid communication between the headspace region and a gas supply. In certain embodiments, the enclosed vessel can include a plurality of closeable inlets, such that the user can select how many analyte containers supply the headspace region. For instance, the enclosed vessel can include a single inlet, or the enclosed vessel can include a plurality (e.g., 2, 3, 4, 5, or more) of closeable inlets.

In some embodiments, the reactivity of two different samples can be evaluated using the disclosed methods and systems. For instance, the enclosed vessel can be in fluid communication with a first container containing a first reagent, and with a second container containing a second reagent. Exposing the head space vapors of the first and second reagents to corona discharge induces gas-phase chemical reactions, the products of which can be evaluated using analyzers such as chromatography and mass spectrometry (e.g., tandem mass spectrometry and/or exact mass spectrometry). The skilled person understands that the such systems may be easily expanded to include additional reagents, in a third container, fourth container, etc. The disclosed systems are especially well suited for high throughput screening of many different reagent combinations. For instance, the first container containing the first reagent can be continuously in fluid communication with the enclosed vessel, while a plurality of different second containers containing different second reagents are sequentially brought into fluid communication with the enclosed vessel. The second containers may be switched manually or robotically, for instance with the aid of an autosampler. For embodiments including additional reagents and containers, the third, fourth, fifth, etc containers may be in continuous fluid communication with the enclosed vessel, or may be sequentially brought into fluid communication with the enclosed vessel, as needed by the end user. FIG. 4B depicts an embodiment where a three-inlet vessel having fixed analyte in chamber B is sequentially combined with a plurality of different reagents A and C. Ionization and analysis can be conducted as described above. The length of ionization can be from 1-5 seconds, from 1-10 seconds, from 2-10 seconds, from 5-10 seconds, from 5-15seconds, from 5-20 seconds, or from 10-20 seconds. In some embodiments, after each ionization period, there is an equivalent amount of time where no voltage is applied. This period of time is sufficient to switch containers and remove all previously ionized species.

The gas phase reactions may be conducted under air atmosphere, or under N₂, Ar, or in the presence of excess H₂ or excess O₂, as needed by the user. After ionization and analysis as described above, and Also disclosed herein are methods of analyzing a plurality of samples, by sequentially bringing a plurality of analyte containers into fluid communication with the enclosed vessel in sequential fashion. In some instances, the enclosed vessel is in fluid communication with a reagent, and a plurality of analyte containers are sequentially communicated with the enclosed vessel. In such embodiments, the reactivity of the analyte sample and while a In other embodiments either manually or robotically. These embodiments can greatly facilitate high-throughput screening assays.

The ESI electrode extends through at least a portion of the headspace. As shown in

FIGS. 1 and 2, the ESI electrode does not contact the walls of the ionization chamber. However, in certain embodiments, the ESI electrode is integrated with at least one wall of the vessel that defines the headspace. For instance, the electrode can be integrated with the bottom wall of the chamber, thereby ensuring the analyte composition contacts the insulated electrode.

The corona electrode is spaced apart from the outlet by a distance of between about 0.1-20 mm, between about 0.5-20 mm, between about 1-20 mm, between about 1-15 mm, between about 1-10 mm, between about 1-7.5 mm, between about 1-5 mm, between about 2.5-20 mm, between about 2.5-15 mm, between about 2.5-10 mm, or between about 2.5-7.5mm.

In some embodiments, the ionization chamber can be configured for use with automated sampler for high-throughput applications. For instance, a robotic arm can sequentially deliver a plurality of sample containers to the ionization chamber, wherein each sample is individually ionized and analyzed.

In certain embodiments, the methods and systems disclosed herein can be used in the analysis of complex mixtures, for instance biofluids. As described in the Examples, reactive olfaction mass spectrometry can be used to detect caffeine in urine at concentrations as low at 200 picogram/ml, and cocaine in plasma at concentrations as low as 100 ng/ml.

### EXAMPLES

The following examples are for the purpose of illustration of the invention only and are not intended to limit the scope of the present invention in any manner whatsoever.

Development of contained nAPCI source. In its fully operational form, the contained nAPCI apparatus consists of an Ag electrode inserted into disposable glass capillary (ID 1.2 mm). This assembly is in turn inserted into a PTFE container (2 mL) which has a stationary screw cap (9 mm) with a through hole to introduce a disposable glass vial (with an integrated 0.5 mL insert) that contains the sample (0.5 mL) and from which the headspace vapor of the analyte is supplied via the glass capillary (FIG. 2). A DC voltage (4-6 kV) applied to the Ag electrode enables the production of corona discharge for direct interaction and ionization of analyte vapor under ambient conditions. The PTFE container itself embodies a valve on the side; the analysis of samples with negligible vapor pressures (VP) was achieved simply by opening this valve, which increases the flowrate of analyte's headspace vapor. Note: the condensed-phase sample (solid or liquid) is placed in the glass vial.

Optimization and Ion Type Characterization. The contained nAPCI source was first optimized using volatile toluene analyte (VP=3.8 kPa). This spectrum was recorded after applying optimized 6 kV of DC voltage to the Ag electrode, which registered three ionic species: hydride elimination to yield [M−H]⁺ ions at m/z 91, molecular ion (M″) at m/z 92,and protonated [M+H] species at m/z 93. Similar ion types were also derived from the headspace vapor analysis of anthracene (VP=8.7×10⁻⁷ kPa) and other hydrocarbons such as cyclohexane, benzene and naphthalene. These results are comparable to desorption atmospheric pressure chemical ionization experiments, except that no pneumatic assistance was employed in the current vapor-phase ionization process. Under this condition, Girard reagent T (VP=4.6×10⁻¹⁰ kPa), a non-volatile organic salt having quaternary ammonium species, was sensitively detected at m/z 132 (the valve open) with no heat supplied to the sample container. The elimination of heat and reagent gases provide simplicity in experimental setup and speed in chemical analysis compared with the corresponding desorption-based ionization methods.

The limit of the contained nAPCI ion source was further tested through the analysis of carminic acid (MW 492 Da), which has a negligible vapor pressure of 5.1×10⁻²⁵ kPa. In this case, a unique ionic species [M+ (3H)] was abundantly detected at m z 495 from the solid untreated sample. The production of this ion type in our contained nAPCI source was also observed for anthracene, p-cymene, and adipic acid (FIG. 2b, e, f). Similar species were observed when using Pt and Fe (instead of Ag) electrodes suggesting the process, which appears to be the addition of two hydrogen atoms across C═C and C═O bonds, is field-induced. That is, the nature of the electrode is less important except its possible role in adsorption of analyte/electrons/protons. The presence of this [M+(3H)]⁺ ion clearly reveals that the mechanism of ion production in the contained nAPCI ion source is not only due to gas-phase chemical ionization but reactions occurring at electrode surface may also contribute substantially. Interestingly, the resultant gas-phase ions are generated from proximal condensed-phase samples with no physical contact, through electrostatic induction (discussed in detail later). The reactive nature of the contained nAPCI ion source was also registered in the formation of dehydrated species [M+H−H₂O]⁺ from ketones, aldehydes and alcohols as well as via the generation of hydroxyl (OH) adducts, iodobenzene and aniline). The identity of analytes were confirmed through MS/MS experiments using collision-induced dissociation.

| | | | MW | VP (kPa, | Observed | MS² Transition(s) |
|---|---|---|---|---|---|---|
| # | Compound | Structure | Da) | 25° C.) | Ion(s) | (CID) |
| 1 | Vitamin D2^{†}* | 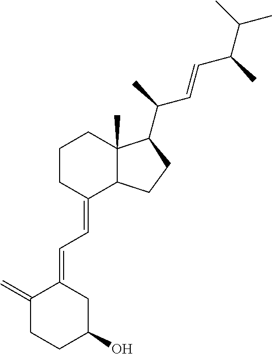 | 397 | 8.5 × 10⁻¹¹ | M^{+•} [M + H]⁺ [M − H₂O]⁺ | 397 → 379, 369, 351, 327, 271 398 → 380, 370, 352, 328, 272 379 → 323, 309, 295, 283, 253, 199 |
| 2 | Hydrocortisone^{†}* | 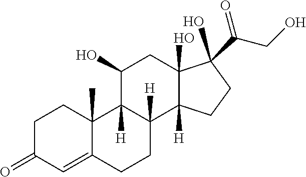 | 362 | 1.6 × 10⁻¹⁴ | [M + H]⁺ [M − H]⁺ | 363 → 345, 327, 309, 297, 267, 121 361 → 343, 325, 297, 279, 121 |
| 3 | Ethyl myristate | 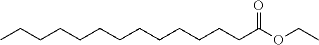 [SMILES: CCCCCCCCCCCCCC(=O)OCC] | 256 | 2.7 × 10⁻⁴ | [M + H]⁺ [M + H − CO]⁺ | 257 → 229, 191 229 → 201, 159, 131, 117, 103, 89 |
| 4 | L-Ascorbic acid^{†}* | 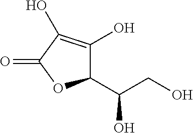 [SMILES: O=C1O[C@H]([C@H](O)CO)C(O)=C1O] | 176 | 2.4 × 10⁻¹¹ | [M + H]⁺ [M − H]⁺ | 177 → 159, 149, 135, 121, 107, 95 175 → 157, 147, 133, 119, 105 |
| 5 | Citral* | 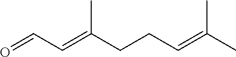 | 152 | 1.2 × 10⁻² | [M + H − H₂O]⁺ [M + H − H₂O − C₃H₄]⁺ [M + H]⁺ | 135 → 119, 107, 93, 79 95 → 67, 55, 41 (HCD) 153 → 135, 109, 95, 81 |
| 6 | Piperonal | 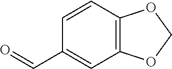 [SMILES: O=Cc1ccc2c(c1)OCO2] | 150 | 1.3 × 10⁻³ | [M + H]⁺ | 151 → 123, 93 |
| 7 | L-Methionine^{†}* | 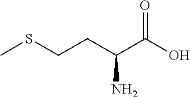 | 149 | 7.8 × 10⁻⁸ | [M + H]⁺ [M + H − OH]⁺ | 150 → 133, 104, 87, 74 (HCD) 133 → 105, 87, 75 |
| 8 | Pyrogallic acid | 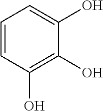 | 126 | 6.4 × 10⁻⁵ | [M + H]⁺ [M − H]⁺ | 127 → 109, 99, 85 125 → 107, 97 |
| 9 | L-Cysteine^{†}* | 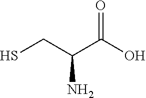 | 121 | 9.0 × 10⁻⁸ | [M + H]⁺ | 122 → 105, 94, 76 |

Another interesting feature of the contained nAPCI ion source is that it predominantly produces positive ions. FIG. 4 illustrates this phenomenon in which protonation occurred for organic acids like acetic acid (VP 2.07 kPa; proton affinity (PA)=784 KJ/mol; ionization energy (IE)=10.65 eV). This suggests that the chemical ionization process might not involve large protonated water clusters as is typically the case in conventional APCI where high flow rates of solvents are used. Note: PA of H⁺ (H₂O) n cluster is 878.6 and 900.0 KJ/mol for n=2 and 3, respectively, both of which cannot protonate acetic acid. This leaves us to conclude that the protonated ions observed in contained nAPCI MS are formed either by field-induced proton transfer reaction (M*⁺_{(surf)}+H₂O→[M+H]⁺ HO*) or by chemical ionization via reaction with hydronium ions (H₃O⁺). Takayama and coworkers have studied positive ion evolution in corona discharge at atmospheric pressure (in the absence of external solvents) and found that the terminal ions are H₃O⁺ and H⁺(H₂O)₂, which is consistent with the current results. We further investigated the influence of other factors (PA, IE, and VP) on the production and absolute intensity of the positive ions ([M−H]⁺, M⁺*, [M+H]⁺) observed in the contained nAPCI source. No particular trend was observed except that the analyte with highest proton affinity dominated the spectrum for mixture samples. For hydrocarbon analytes, both M⁺* and [M−H]⁺ were often observed together.

Quantification and Direct Biofluid Analysis. As already shown, vapor pressure is of little importance in contained nAPCI MS. However, this does not mean ion signal is concentration independent. Based on gas law, the number of moles in headspace vapor is directly proportional to vapor pressure if volume and temperature are held constant. We determined this to be true in our contained nAPCI experiment using HNO₃ vapor. Here, different HNO₃ solutions were prepared at varying concentration (40, 45, 50, 60, 65%), each with known vapor pressure. Headspace vapor from each of the prepared HNO₃ solutions was seeded into 10 μL of water plug contained in a removable pulled glass capillary. After 1 h of vapor seeding, the resultant solution in which the HNO3 vapor has been collected was diluted into 2 mL of water and the pH measured. Obtained pH values were converted into hydrogen ion concentrations, yielding flowrates in the nmol/min range. Most importantly, the determined headspace vapor flowrates varied linearly with known partial pressure of HNO3solutions. Likewise, a calibration curve was successfully constructed for acetone, an important metabolism marker, when spiked in raw urine; contained nAPCI ion signal increased linearly (R²=0.97) with acetone concentration and a good limit of quantification (200 pg/mL) was observed. Similar concentration-dependent analysis was achieved for pyridine in roasted coffee, which was consistent with reported trends. Here, cocaine dissociated to give the characteristic fragment ion at m/z 182 upon collisional activation. Limit of detection for cocaine spiked in serum was found to be 1 ng/mL, which corresponds to only 0.18 attogram per mL of cocaine vapor inside of our contained nAPCI source. Therefore, the contained nAPCI MS platform is a powerful sensor that can detect odor concentrations 5 million times lower than most sensitive dogs. Carryover issues are observed to be minimal in the contained nAPCI experiment as illustrated for real-time analysis of methyl anthranilate (1), benzene (2), furfural (3), toluene (4) and benzaldehyde (5).

Electrostatic Induction and Reactive Olfaction. The ultra-sensitivity observed in the contained nAPCI experiment is due to the fact that the total analyte vapor concentration results from the combined effects of (natural) analyte vapor pressure and electrostatic charging of the proximal condensed-phase sample leading to the liberation of particles from the sample. That is, the applied DC voltage is expected to induce the separation of partial positive (δ+) and negative (δ−) charges. Charges of the same polarities accumulate in close proximity, in response to the applied voltage, which leads to the instantaneous liberation/desorption of particles as a result of Coulombic repulsion. (The effects will be similar to electroscope experiments in which the two leaves separate as a results of charge induction). We have observed the number of electrostatically desorbed vapor-phase particles to be directly proportional to applied voltage and distance between the Ag electrode and the sample, an effect that is consistent with Coulomb's law (Fₑ˜(q₁q₂)/r²), where q represent charges on the electrode and a surface particle, and r is the distance between the electrode and the particle. Thus, a temporal increase (1-2 s) in Ag electrode voltage (8 kV) was used to achieve ionization of analytes with negligible vapor pressures (e.g., carminic acid, hydrocortisone, and vitamin D2). In this case, analyte desorption is temperature independent although the subsequent ionization and signal-to-noise ratio of the electrostatically liberated particles can be influenced by MS inlet capillary temperature.

Direct Analysis of Perfumes and Beverages. The structures and identities of the 25 most abundant compounds in several colognes (Lacoste, Dolce & Gabbana, and Old Spice) were confirmed using MS/MS experiments, and via accurate mass measurements. The three colognes can be differentiated based on the chemical composition of their headspace vapors, without prior extraction or pre-concentration. Each major compound can be related to a distinctively known aroma or other function (e.g., UV absorption properties in Lacoste cologne), confirming their structural identification by contained nAPCI MS. For example, acetal (m/z 135; refreshing, pleasant odor) and a-isomethylionone (m/z 107; floral, woody scent) were detected as one of the most abundant compounds in Lacoste Touch of Spring, which is well known for its fresh, floral and sandalwood notes. The orange blossom and jasmine middle notes of Dolce & Gabbana Femme perfume was also confirmed using nAPCI MS by detecting of methyl anthranilate (m/z 152; orange-flower odor) and methyl N-methylanthranilate (m/z 166; fruity, floral scent).

The same olfaction approach was applied for the analyses of coffee and carbonated drinks. Here too, the top 26 most abundant compounds were characterized for two types of ground coffee, two types of instant coffee, and three types of brewed coffee with different roast levels. While solid coffee showed distinct composition for volatile and nonvolatile components, brewed coffee were found to be very similar by headspace vapor chemistry. However, the abundance of pyridine was dramatically increased from light roast to dark roast coffee, a result that is in good agreement with coffee chemistry in which the alkaloid trigonelline partially degrades during roasting to produce pyridine and nicotinic acid.

Finally, five Coca Cola carbonated drinks (Cherry Coca-Cola, Mello Yello, Fanta, Coca-Cola, and Sprite) were analyzed without sample preparation and no physical contact or heating. We detected different caffeine content and unique compounds that can be related to known flavors. For example, large amount of benzaldehyde (m/z 107; cherry flavor) was detected in Cherry Cola, which is absent in all other carbonated drinks tested. The reactive olfaction sampling confirmed Mello Yello to be a highly-caffeinated, citrus-flavored soft drink. No caffeine, m/z 195, was detected in Fanta and Sprite as prescribed by Coca-Cola Company. Maltol (m/z 127; caramellic flavor), was detected more abundantly in the Cola drinks (c.g., Coca-Cola and Cherry Cola) compared with the citrus flavored beverages (c.g., Fanta and Mello Yello). Preservatives such as benzoic acid (m/z 123) were also detected in all the tested carbonated drinks. These consistent results demonstrate that due to its high sensitivity the new contained nAPCI MS platform can provide unique opportunity to rapidly study not only odor but also flavor chemistry using headspace vapors.

### Example 1: Ionization chamber with separate ESI and corona electrode.

This embodiment is depicted in FIG. 1 and is capable of three spray modes: a) Non-contact nESI in which the analyte solution present in a disposable glass capillary (ID 1.2 mm; ˜5 μm pulled tip) is electrically charged through electrostatic induction. That is, the Ag electrode on which the DC high voltage (HV) is applied is not in physical contact with the analyte solution. Instead, a ˜1 cm air gap is created, and as little as 1 kV applied voltage is able to induce electrostatic charging, which causes the release of charged droplets from the capillary tip that are sampled by the mass spectrometer. b) Non-contact nESI/nAPCI mode, where both charged droplets and plasma are simultaneously produced when potentials above the breakdown voltage (4 kV) of air are applied. Here, the presence of auxiliary Ag electrode placed in a collimating glass capillary (ID 1.2 mm) allows the exposure of the resultant solvated/gas-phase ions to corona discharge. Note: a single HV power supply (available from the MS instrument) is used, plus no further modification of the conventional nESI source is required except for the attachment of the auxiliary Ag electrode, which does not obstruct nESI performance at low spray voltages. c) Electrophoretic separation spray mode in which polarity reversing (from negative to positive voltage) enables detection of highly re-solved multiply-charged protein ions under high voltage conditions in the presence of concentrated inorganic salts.

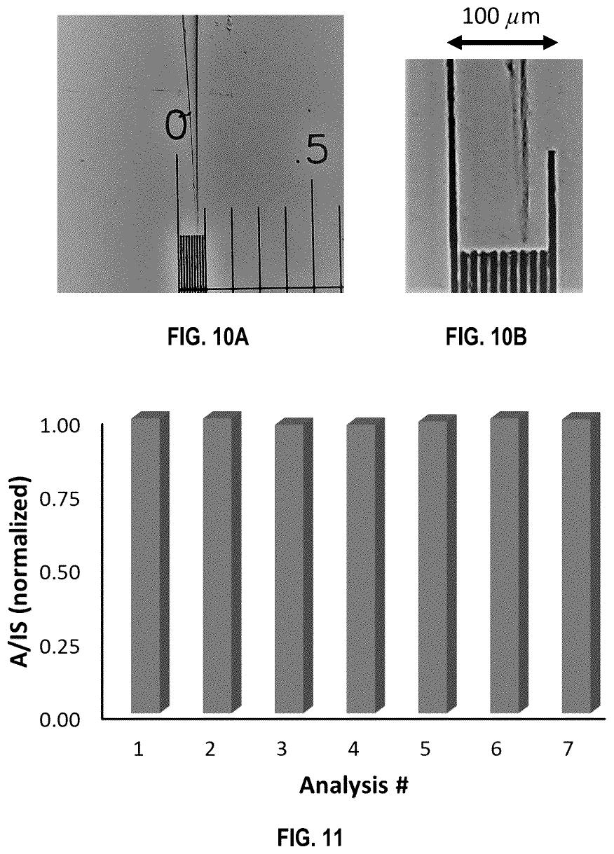

FIG. 5 compares tip stability under different spray conditions. Not surprisingly, Joule heating generated after applying 5-8 kV to an electrode in contact with analyte solution (conventional nESI) is sufficient to break the tip of the glass capillary. Joule heating is significantly reduced in the non-contact spray mode due to the presence of the air gap (resistivity of air is >1.3×1016 Ω at 200° C.), which leads to a much more stable tips at the same ap-plied voltages. Interestingly, the glass tips became remarkably stable in the presence of the proximal auxiliary Ag electrode. In this case, the well-known cooling effects of corona discharge further reduces Joule heating by inducing rapid movement of air/droplets around the tip arca.

A methanol solution containing equimolar (200 μM) mixture of 5-fluorouracil (1), caffeine (2), β-estradiol (3), cocaine (4), and vitamin D2 (5) was ionized using the conventional contact mode nESI source at an applied voltage of 2 kV. As can be observed, only the polar cocaine analyte with high proton affinity (930 KJ/mol) was detected at m z 304.Caffeine (MW 194), another polar analyte was significantly suppressed despite having relatively high proton affinity (914 KJ/mol). Not surprisingly, detectable ion signal was not observed for 1, 3 and 5, even from individual solutions (i.e., in the absence of other analytes) at 10 ppm concentration levels. Similarly, protonated cocaine ions were predominantly detected when the mixture was analyzed by non-contact nESI operated using 2 kV spray voltage in the absence of corona discharge. Upon increasing the voltage from 2 to 6 kV, corona discharge was induced on the auxiliary Ag electrode, expecting the ionization of both polar and non-polar compounds delivered by the spray plume. The corresponding non-contact nESI/nPACI positive-ion mass spectrum is shown in at 2b below, which confirms the presence of all five analytes. Compounds 1, 2, and 4 were observed as protonated (M+H)⁺ ions at m/z 131, 195, and 304, respectively. Like conventional APCI experiment, dehydration reactions involving (pseudo) molecular ions were also observed with β-estradiol (MW 272) registering as [M+H−H₂O]⁺ species at m/z 255. Radical species M*⁺ and (M−H₂O)*⁺ were also detected for vitamin D2 (MW 397) at m/z 397 and 379, respectively. Other nonpolar compounds (thymol, surfynol, phenol), which could not be detected by conventional nESI at 1 ppm level, were also successfully characterized. These results establish the inventive MS platform as efficient method to simultaneously ionize both polar and nonpolar compounds simply by increasing voltage from 2 to 6 kV.

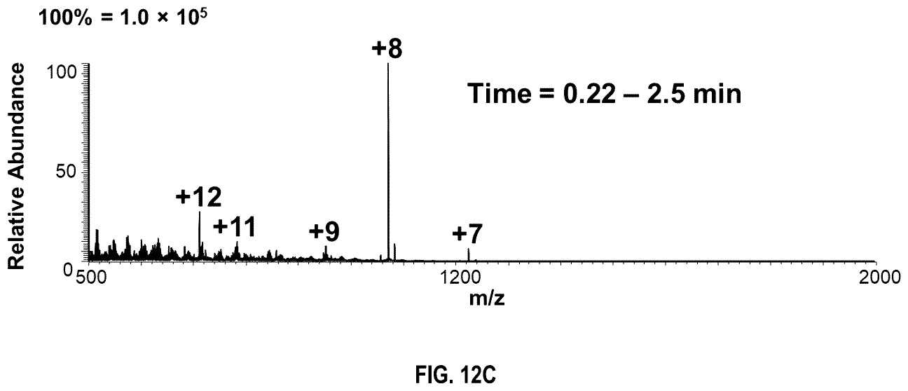

3 μL of ethyl acetate was first placed in the sharp tip of the disposable glass capillary. A small volume (5 μL) of the biofluid sample spiked with a selected analyte was then introduced on the top of the ethyl acetate solvent followed by a short shake to initiate liquid-liquid extraction in the capillary as well as to remove air bubbles that may be present at the capillary tip. Note that the three strokes of shaking employed here form part of the regular nESI MS analysis, and do not add extra steps to the analytical process. Often, the shaking process resulted in the disintegration of the biofluid into smaller compartments, which facilitated efficient extraction via increased interfacial contact with the extracting organic solvent. The high buoyancy of the less viscous ethyl acetate solvent (density 0.902 g/mL) draws the clean extract to the sharp tip of the glass capillary for easy analysis by non-contact nESI/nAPCI MS. Moreover, since the Ag electrode is not in direct contact with sample/solvent, extraction equilibrium is not disturbed; a contact mode experiment where the electrode is pushed through the biofluid will reintroduce contaminants into the extract, which may cause matrix effects during analysis. The pure extract typically offered a stable 1 min spray time, which is sufficient for complete MS analysis, including tandem MS (MS/MS). The optimal amount of extraction solvent (3 μL) was used to compromise between spray time and signal intensity. For instance, applying 3 μL versus 5 μL of ethyl acetate in-creased analyte to internal standard (A/IS) signal ratio for cocaine extracted from serum by a factor of 10 (FIG. 8). Volumes lower than 3 μL result in decreased spray times (<1 min).

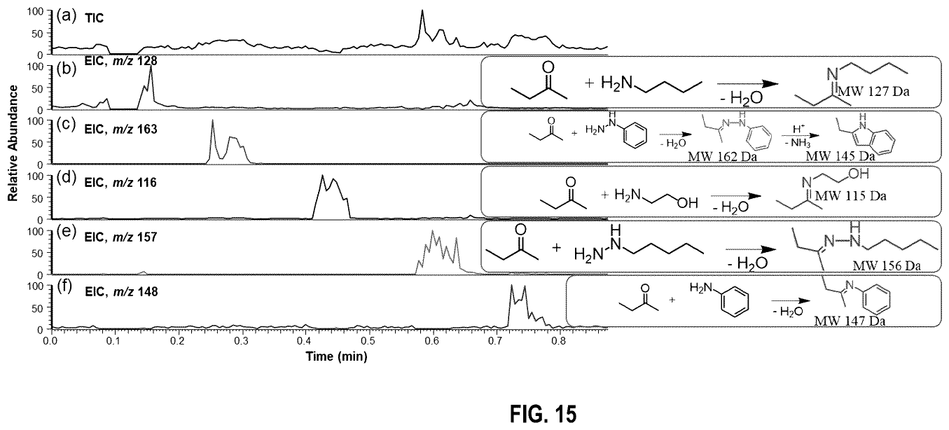

Representative product ion spectrum for 50 pg/mL cocaine spiked in undiluted blood (5 μL) registered the diagnostic fragment ion at m/z 182 in high abundance (FIG. 14). FIG. 14 shows a calibration curve derived from comparing the product ion (m/z 182) intensity at different concentrations of cocaine analyte (50-1000 pg/mL) to that of internal standard (IS, cocaine-d3, 500 pg/mL) spiked into the blood sample. Excellent linearity (R2=0.999) and limit of detection (LOD) of 12 pg/mL were achieved. LODs for other analytes are shown below:

| | | Voltage | |
|---|---|---|---|
| Analyte | Sample | (kV) | LOD (ng/mL) |
| Cocaine | Serum | 2 | 0.5 × 10⁻³ |
| | Blood | | 1.2 × 10⁻² |
| | Urine | 6 | 0.01 |
| β-Estradiol | Blood | 6 | 10 |
| Caffeine | Blood | 6 | 15 |

Aside from high extraction efficiency and minimal matrix effects, high ionization efficiency from the ethyl acetate extract, saturated with water from the biofluid, is thought to contribute to the observed high sensitivity.

Additional enhancing effect may arise from the smaller initial droplets expected from the low flow-rate (50 nL/min) non-contact mode nESI experiment (comparable tip size of 5um (FIG. 10) yielded 60 nL/min in traditional nESI). Another factor influencing ionization efficiency, and hence sensitivity, is our ability to generate different ion types simply by using higher spray voltages. For example, the weakly polar and high eluent strength (0.58) properties of ethyl acetate is expected to result in high extraction efficiency for steroid analytes such as β-estradiol. However, analysis by contact mode nESI MS often yields in low sensitivity due to low proton affinity. Derivatization reactions are typically used to overcome this limitation. A 10 ng/mL LOD was observed for β-estradiol in whole human blood by utilizing an optimized spray voltage of 6 kV, which enable the detection of (M−H₂O)·+ ion in tandem MS (m/z 225→159) mode without derivatization reactions.

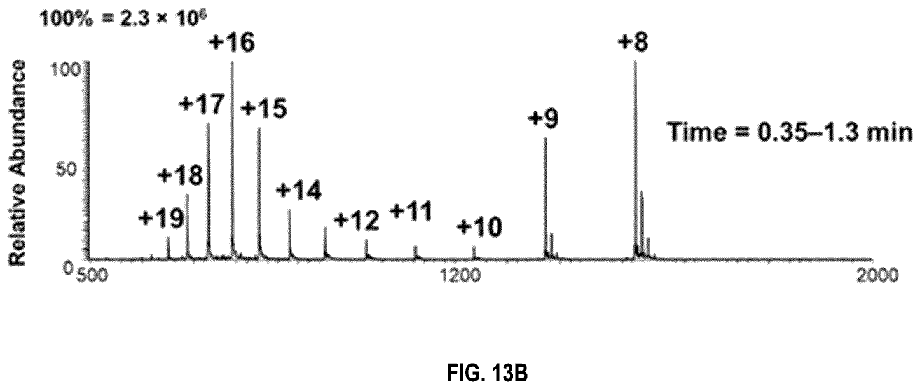

The fact that the non-contact nESI/nAPCI source is operated without the assistance of nebulizing gases, and in the presence of limited solvent molecules under the nL/mL flow-rate conditions suggests highly reactive ionic species [e.g., H+(H₂O)n; where n=1 or 2] might be involved in the ionization process compared with the conventional APCI experiment, which employs N2 gas and high solvent flow rates (μL/mL). Importantly, biosamples can be reanalyzed by repeated cycles of in-capillary ex-traction and ionization. Comparable MS signal was detected for cocaine in serum after seven cycles of analysis (FIG. 11).

### Electrophoretic Separation.

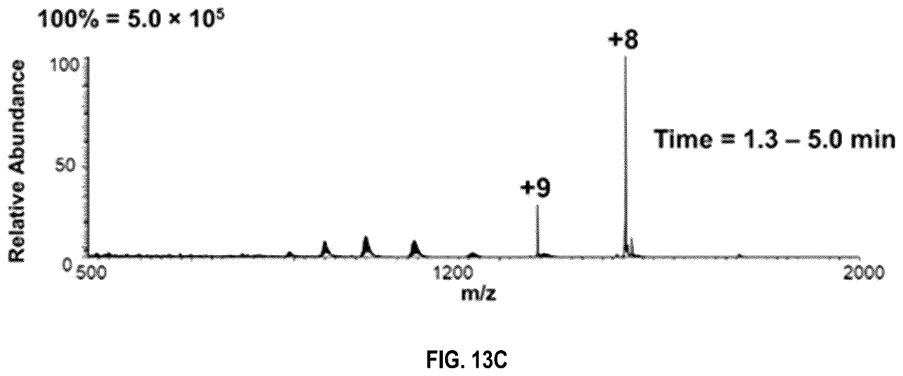

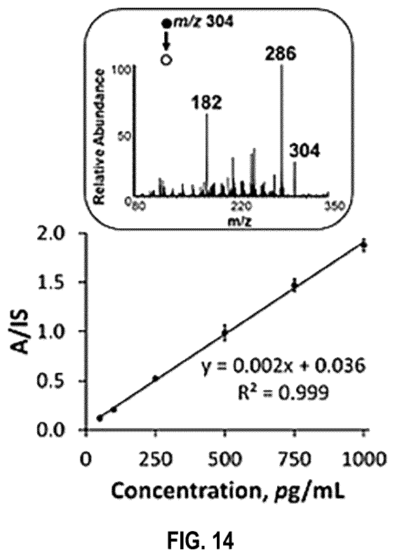

The last application examined for the new ion source was electrophoretic desalting and detection of proteins in concentrated salt solutions. We employed polarity-reversing on our non-contact nESI/nAPCI platform where a step potential was used starting from negative to positive high voltage polar-ities. A unique capability provided by our experimental setup is the fact that large step voltage differences (e.g., from −5 kV to +2 kV) can be used without damaging the disposable glass tip due to reduced Joule heating. FIG. 13 shows real-time separation of cytochrome c in 1X phosphate-buffered saline solution (PBS, 137 mM NaCl, 2.7 mM KCl, 10 mM Na₂HPO₄ and 1.8 mM KH2PO4) ob-tained after applying −5 kV for 10 s followed by the application of +2 kV (see insert of FIG. 4a; 0.1% of formic acid was added to the buffered protein solution). There are three distinct time domains during the mass analysis at +2 kV: highly charged protein species are detected first (between 0-0.35 min) suggesting that highly un-folded proteins did not respond much to the polarity switching effect, concentrating them to the tip of the capillary. A broad range of protein charge states emerged within 0.35-1.3 min of spray time indicating slow mixing of separated protein conformations. All the slow moving denatured bulky proteins was exhausted after 1.3 min of continuous spray at which point only low charge state proteins were detected for the remaining 3.7 min spray time. Overall, the solution with depleted salt lasted for about 5 min, which is sufficient for complete MS analysis. Similar desalting effect was observed for ubiquitin using −5 kV to +2 kV step voltage conditions with 2.5 min of total spray time (FIG. 12). Note: without polarity reversing, proteins could not be detected in 1X PBS buffer employing either our setup or the regular contact mode nESI source. With polarity reversing, our setup offered acceptable separate in real-time not only for the temporal desalting of biomolecules but also the spatial separation of different conformations of a single protein. The later effect has not been reported before in all other polarity-reversing experiments. The separation is achieved based on the difference in electrophoretic mobilities, and in some cases can be achieved without adding acid.

### Example 2: High throughput screening

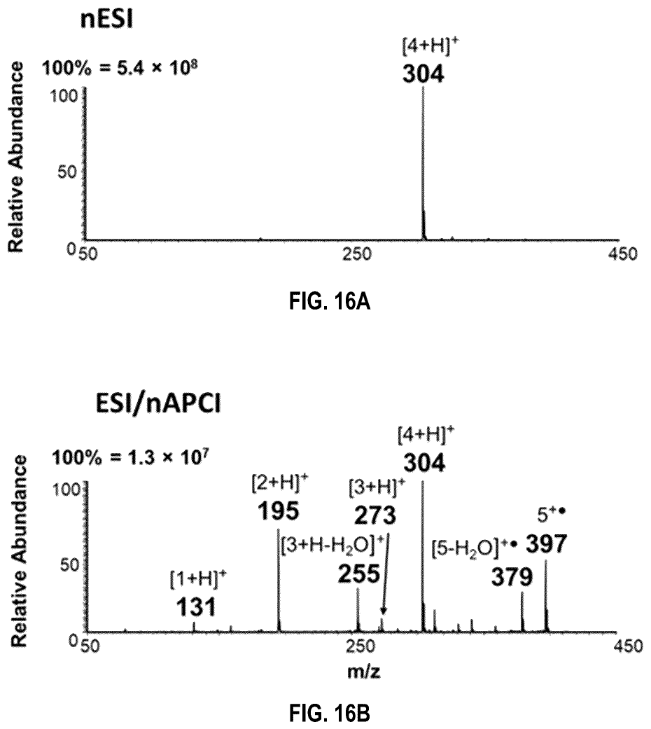

To demonstrate the high-throughput capabilities of this new contained-APCI MS screening platform, five different compounds (n-butylamine, phenylhydrazine, ethanolamine, pentylhydrazine, and aniline) were separately combined with 2-butanone vapor in real-time. Exposure time for each reagent was kept at 5 s, followed by another 5 s delay time yielding a total of 10 s interval between reactants, which was found optimal to limit carryover effect. The non-contact nature of the contained-APCI platform also aids in limiting contamination. Therefore, the reactivity of all five reagents could be screened in under 60 s. The results of this experiment are summarized in FIG. 15, which show clean product formation for each reactant without interference from previously analyzed reagents. While this experiment attempts to differentiate amines from hydrazine using their reaction with 2-butanone, it can be observed that the majority of the reactants form similar product making functional group identification challenging. This issue can be addressed through the implementation of other reactions in parallel. Here is where the high-throughput experimentation capabilities of the contained-APCI MS platform can be realized. In this respect, the experimental setup described in FIG. 4B having three inputs is not intended for three component reaction screening. Instead, the three inputs are proposed to allow a given analyte (reagent B, FIG. 1) to be interrogated by two different reagents (A and C) in parallel. For example, both n-butylamine and butylhydrazine react with 2-butanone to give the corresponding Schiff's base via the loss of water molecule. By replacing the 2-butanone reagent with pyrylium cation, only the amine is expected to react to product the corresponding pyridinium cation. By combining this high-throughput experimentation procedure with tandem MS, it should be possible to obtain complete structural information in a matter of seconds. The process can be accomplished manually or via a robotic arm. Analytically, the ability to perform this experiment manually will be advantageous in field applications (i.e., on-site analysis) for complex mixture analysis, where the front-end reactions can produce a shift in mass for the analyte, thereby providing more confidence for MS/MS experiments conducted without prior separation.

### Additional Embodiments

1. A method for detecting organic compound in an analyte composition comprising
a) providing the composition in an enclosed chamber defining a headspace and an outlet, the outlet in fluid communication with the headspace;
b) supplying a direct current (DC) voltage to an ESI electrode proximate to the composition to generate charged droplets in the headspace;
c) passing the charged droplets through the outlet; and
d) exposing the charged droplets to a corona discharge.

2. The method according to embodiment 1, wherein the electrode is spaced from the composition at a distance that is from about 0-10 cm, from about 0-8 cm, from about 0-6 cm, from about 0-4 cm, from about 0-2 cm, from about 0-1 cm, about 0 cm, from about 0.1-10 cm, from about 0.1-5 cm, from about 0.1-1.5 cm, or from about 0.5-1.5 cm.

3. The method according to embodiment 1 or embodiment 2, wherein the corona discharge is produced by a corona electrode that is spaced from the outlet at a distance from 0.1-20 mm, between about 0.5-20 mm, between about 1-20 mm, between about 1-15 mm, between about 1-10 mm, between about 1-7.5 mm, between about 1-5 mm, between about 2.5-20 mm, between about 2.5-15 mm, between about 2.5-10 mm, or between about 2.5-7.5 mm.

4. The method according to any of embodiments 1-3, wherein the outlet is in fluid communication with an analyzer.

5. The method according to any of embodiments 1-4, wherein the enclosed chamber is a glass capillary.

6. The method according to any of embodiments 1-5, wherein the outlet comprises a tip.

7. The method according to any of embodiments 1-6, wherein an organic solvent is disposed between the analyte composition and the outlet.

8. The method according to embodiment 7, wherein the organic solvent comprises from 0.1-5% water.

9. The method of any of embodiments 1-8, comprising applying a DC voltage greater than about 1 kV to the ESI electrode.

10. The method of any of embodiments 1-9, comprising applying a DC voltage greater than about 3 kV to the corona electrode.

11. The method of any of embodiments 1-10, comprising applying the same DC voltage to the ESI electrode and corona electrode.

12. The method of any of embodiments 1-11, wherein the ESI electrode and corona electrode are in electrical communication.

13. The method of any of embodiments 1-12, wherein the ESI electrode and corona electrode are integrated.

14. The method of any of embodiments 1-13, comprising applying a first voltage for a first period of time, followed by applying a second voltage for a second period of time. 15. The method of embodiment 14, wherein the first and second voltages are of opposite polarity.

16. The method of embodiment 14 or embodiment 15, wherein the first voltage is of negative polarity, and the second voltage is of positive polarity.

17. The method of any of embodiments 14-16, wherein the first period of time is from 1-60 second, from 1-40 seconds, from 1-30 seconds, from 1-20 seconds, from 5-30 seconds, from 5-20 seconds, or from 5-15 seconds.

18. The method of any of embodiments 1-17, wherein the analyte composition comprises a biofluid.

19. The method of any of embodiments 1-18, wherein the analyte composition comprises urine, blood serum, plasma, saliva, sweat, tears, or a combination thereof.

20. The method of any of embodiments 1-19, wherein the analyzer comprises a mass spectrometer.

21. The method of any of embodiments 1-20, wherein the analyzer comprises an ion trap mass spectrometer, Orbitrap mass spectrometer, or triple quadrupole mass spectrometer.

22. The method of any of embodiments 1-21, wherein the charged droplet is combined with a carrier gas prior to exposure to the corona discharge.

23. The method of any of embodiments 1-22, wherein the charged droplet is combined with a reagent gas prior to exposure to the corona discharge.

24. The method of any of embodiments 1-23, wherein the reagent gas comprises an acid, a base, an oxidant, a solvent, or a combination thereof.

25. An ionization chamber comprising:
a) an enclosed vessel defining a headspace, at least one inlet and an outlet, the inlet and outlet each in fluid communication with the headspace, the inlet for receiving an analyte;
b) an ESI electrode in electrical communication with the headspace;
c) a corona electrode disposed outside the chamber and adjacent to the outlet; and
d) wherein the outlet is configured to permit fluid communication between the headspace and an analyzer.

26. The chamber of embodiment 25, wherein the corona electrode is spaced apart from the outlet by a distance of between about 0.1-20 mm, between about 0.5-20 mm, between about 1-20 mm, between about 1-15 mm, between about 1-10 mm, between about 1-7.5 mm, between about 1-5 mm, between about 2.5-20 mm, between about 2.5-15 mm, between about 2.5-10 mm, or between about 2.5-7.5 mm.

27. The chamber according to embodiment 25 or embodiment 26, wherein the outlet comprises a valve.

28. The chamber according to any of embodiments 25-27, wherein the inlet is removably coupleable to an analyte container.

29. The chamber according to any of embodiments 25-28, wherein the inlet comprises a threaded surface for coupling to a mating threaded surface of an analyte container.

30. The chamber according to any of embodiments 25-30, wherein the ESI electrode extends through at least a portion of the headspace.

31. The chamber according to any of embodiments 25-30, wherein the ESI electrode and corona electrode are physically integrated.

32. The chamber according to any of embodiments 25-31, wherein the ESI electrode is integrated with at least one wall of the vessel that defines the headspace.

33. The chamber according to any of embodiments 25-32, wherein the electrode is a wire. 34. The chamber according to any of embodiments 25-32, wherein the electrode is a plate.

35. The chamber of any of embodiments 25-34, wherein the electrode is surrounded by a glass rod.

36. The chamber of any of embodiments 25-35, wherein the chamber further comprises a gas valve, configured to permit fluid communication between the headspace region and a gas supply.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1-36. (canceled)

37. A method for detecting an organic compound in an analyte composition comprising;
a) providing the composition in an enclosed chamber comprising an outlet;
b) supplying a first direct current (DC) voltage to a first electrode, wherein said first electrode is an ESI electrode proximate to the composition to generate charged droplets in the chamber;
c) passing the charged droplets out of the chamber through the outlet;
d) exposing the charged droplets to a corona discharge, said corona discharge generated by supplying a second direct current (DC) voltage to a second electrode, wherein said second electrode is corona electrode.

38. The method of claim 37, wherein the first electrode is spaced from the composition at a distance from about 0-4 cm.

39. The method of claim 37, wherein the second electrode is spaced from the outlet at a distance between about 1-10 mm.

40. The method of claim 37, wherein the enclosed chamber is a glass capillary.

41. The method of claim 37, wherein the outlet comprises a tip.

42. The method of claim 37, wherein an organic solvent is disposed between the analyte composition and the outlet.

43. The method of claim 37, wherein the first electrode is disposed inside the enclosed chamber.

44. The method of claim 37, wherein the second electrode is outside the enclosed chamber.

45. The method according to claim 37, wherein the first voltage is applied for a first period of time, followed by applying the second voltage for a second period of time.

46. The method according to claim 37, wherein the first voltage and second voltages are of opposite polarity.

47. The method according to claim 37, wherein the analyte composition comprises a biofluid.

48. The method according to claim 37, wherein the analyte composition comprises urine, blood serum, plasma, saliva, sweat, tears, or a combination thereof.

49. The method according to claim 37, wherein the outlet is in fluid communication with an analyzer.

50. The method according to claim 49, wherein the analyzer comprises a mass spectrometer.

51. An ionization chamber comprising:
a) an enclosed vessel defining a headspace, at least one inlet and an outlet, the inlet and outlet each in fluid communication with the headspace, the inlet for receiving an analyte;
b) a first electrode in electrical communication with the headspace, wherein the first electrode is an ESI electrode;
c) a second electrode disposed outside the chamber and adjacent to the outlet, wherein the second electrode is a corona electrode; and
d) wherein the outlet is configured to permit fluid communication between the headspace and an analyzer.

52. The chamber according to claim 51, wherein the first electrode is disposed inside the enclosed chamber.

53. The chamber according to claim 51, wherein the outlet comprises a tip.

54. The chamber according to claim 51, wherein the second electrode is spaced from the outlet at a distance between about 1-10 mm.

55. The chamber according to claim 51, wherein the inlet is removably coupleable to an analyte container.

56. The chamber according to claim 51, wherein the first electrode extends through at least a portion of the headspace.
